(19) United States
(12) Patent Application Publication
(10) Pub. No.: US 2026/0255059 A1
(43) Pub. Date: Aug. 27, 2026

(54) CAMERA SYSTEM AND APPLICATION PROCESSOR

(71) Applicants: SONY SEMICONDUCTOR SOLUTIONS CORPORATION, KANAGAWA (JP); SONY GROUP CORPORATION, TOKYO (JP)

(72) Inventors: KENYA HAYASHI, KANAGAWA (JP); YASUNORI TSUKUDA, KANAGAWA (JP); CHIKASA NISHIMURA, TOKYO (JP)

(21) Appl. No.: 19/161,909

(22) PCT Filed: Jan. 19, 2024
(86) PCT No.: PCT/JP2024/001441

§ 371 Date: Sep. 3, 2025

(30) Foreign Application Priority Data
Mar. 14, 2023 (JP) 2023-039435

(51) Int. Cl. H04N 23/67; H04N 23/56; H04N 23/63

(52) U.S. Cl. CPC H04N 23/671; H04N 23/56; H04N 23/632

(57) ABSTRACT

It is possible to suppress a decrease in focus accuracy due to a change in a distance measurement environment. A camera system includes: a distance measurement sensor that generates distance measurement data on the basis of distance measurement to a target object; an imaging device that generates image data on the basis of imaging of an imaging range including a distance measurement position of the target object; and an application processor that generates focus control information of the imaging device on the basis of the distance measurement data and the image data. The application processor may output distance measurement control information including at least any one of a light emission interval, a light emission intensity, a light emission position, a continuous light emission count, a light emission pulse width, or a light reception position to the distance measurement sensor.

### TECHNICAL FIELD

The present technology relates to a camera system and an application processor. Specifically, the present technology relates to a camera system and an application processor capable of generating focus control information on the basis of distance measurement data and image data.

### BACKGROUND ART

There is a technique of assigning depth information to a two-dimensional image to enable three-dimensional mapping. For example, there has been proposed a technique for generating three-dimensional positional information in combination with image information acquired by a camera module by measuring a time during which a beam emitted to a space is reflected by a target object and reciprocates in cooperation with the camera module (see, for example, Patent Document 1).

### CITATION LIST

### Patent Document

Patent Document 1: Japanese Patent Application Laid-Open No. 2021-15089

### SUMMARY OF THE INVENTION

### Problems to be Solved by the Invention

However, in the above-described conventional technique, since only the distance measurement data is used to estimate the position of the target object in the space of the partial space group, there is a possibility that the prediction accuracy of the position of the target object is deteriorated depending on the distance measurement environment.

The present technology has been made in view of such a situation, and an object of the present technology is to suppress a decrease in focus accuracy due to a change in a distance measurement environment.

### Solutions to Problems

The present technology has been made to solve the above-described problems, and a first aspect thereof is a camera system including: a distance measurement sensor that generates distance measurement data on the basis of distance measurement to a target object; an imaging device that generates image data on the basis of imaging of an imaging range including a distance measurement position of the target object; and an application processor that generates focus control information of the imaging device on the basis of the distance measurement data and the image data. This brings about an effect that the focus control information is generated on the basis of the distance measurement data while enabling reference to the image data.

Furthermore, in the first aspect, the application processor may output distance measurement control information including at least any one of a light emission interval, a light emission intensity, a light emission position, a continuous light emission count, a light emission pulse width, or a light reception position to the distance measurement sensor. This brings about an effect that the focus control is performed on the basis of the distance measurement control information.

Furthermore, in the first aspect, a prediction section that predicts a three-dimensional position of the target object on the basis of the distance measurement data and the image data may be included. This brings about an effect that the focus position can be set following the movement of the target object.

Furthermore, in the first aspect, the prediction section may predict a three-dimensional position of the target object on the basis of a three-dimensional motion vector of the target object. This brings about an effect that the three-dimensional position of the target object is predicted.

Furthermore, in the first aspect, a control section that performs light emission control of the distance measurement sensor, light reception control of the distance measurement sensor, and focus control of the imaging device on the basis of a prediction result of a three-dimensional position of the target object may be included. This brings about an effect that the light emission control, the light reception control, and the focus control are performed while following the three-dimensional movement of the target object.

Furthermore, in the first aspect, the control section may control at least any one of a light emission interval, a light emission intensity, a light emission position, a continuous light emission count, a light emission pulse width, or a light reception position of the distance measurement sensor on the basis of a prediction result of a three-dimensional position of the target object. This brings about an effect that the distance measurement condition is changed following the movement of the target object.

Furthermore, in the first aspect, a display section that displays the target object and a three-dimensional motion vector of the target object may be further included. This brings about an effect that three-dimensional movement of the target object becomes visible.

Furthermore, in the first aspect, the application processor may recognize a position of the target object on the basis of image data obtained by phase difference autofocus, and perform focus control based on the distance measurement data on the basis of a recognition result of the position of the target object. This brings about an effect that the position of the target object is recognized before the distance measurement of the target object.

Furthermore, in the first aspect, a recognition section that performs object recognition of the target object on the basis of the image data generated by the imaging device may be included. This brings about an effect that the target object to be subjected to the focus control can be specified.

Furthermore, in the first aspect, the control section may perform focus control of the imaging device on the basis of an object recognition result recognized by the recognition section. This brings about an effect that focus control is performed with a specific target object as a target.

Furthermore, a second aspect may be an application processor including: a data input section that inputs distance measurement data to a target object and image data of an imaging range including a distance measurement position of the target object; and a data output section that outputs focus control information for imaging the target object on the basis of the distance measurement data and the image data. This brings about an effect that the focus control information is generated on the basis of the distance measurement data while enabling reference to the image data.

Furthermore, in the second aspect, the application processor may output distance measurement control information including at least any one of a light emission interval, a light emission intensity, a light emission position, a continuous light emission count, a light emission pulse width, or a light reception position. This brings about an effect that the focus control is performed on the basis of the distance measurement control information.

Furthermore, in the second aspect, a prediction section that predicts a three-dimensional position of the target object on the basis of the distance measurement data and the image data may be included. This brings about an effect that the focus position can be set following the movement of the target object.

Furthermore, in the second aspect, the prediction section may predict a three-dimensional position of the target object on the basis of a three-dimensional motion vector of the target object. This brings about an effect that the three-dimensional position of the target object is predicted.

Furthermore, in the second aspect, a control section that performs light emission control of a distance measurement sensor, light reception control of the distance measurement sensor, and focus control of an imaging device on the basis of a prediction result of a three-dimensional position of the target object may be included. This brings about an effect that the light emission control, the light reception control, and the focus control are performed while following the three-dimensional movement of the target object.

Furthermore, in the second aspect, the control section may control at least any one of a light emission interval, a light emission intensity, a light emission position, a continuous light emission count, a light emission pulse width, or a light reception position of the distance measurement sensor on the basis of the prediction result of the three-dimensional position of the target object. This brings about an effect that the distance measurement condition is changed following the movement of the target object.

In addition, in the second aspect, display control information of the target object and a three-dimensional motion vector of the target object may be output. This brings about an effect that three-dimensional movement of the target object becomes visible.

Furthermore, in the second aspect, the position of the target object may be recognized on the basis of image data obtained by phase difference autofocus, and focus control based on the distance measurement data may be performed on the basis of a recognition result of the position of the target object. This brings about an effect that the position of the target object is recognized before the distance measurement of the target object.

Furthermore, in the second aspect, a recognition section that performs object recognition of the target object on the basis of the image data including the target object may be included. This brings about an effect that the target object to be subjected to the focus control can be specified.

Furthermore, in the second aspect, the control section may perform focus control of the imaging device on the basis of the object recognition result recognized by the recognition section. This brings about an effect that focus control is performed with a specific target object as a target.

### BRIEF DESCRIPTION OF DRAWINGS

FIG. 1 is a block diagram illustrating a configuration example of a camera system according to a first embodiment.

FIG. 2 is a diagram illustrating an example of prediction of a three-dimensional motion vector of a target object in the camera system according to the first embodiment.

FIG. 3 is a flowchart illustrating an example of autofocus control of the camera system according to the first embodiment.

FIG. 4 is a diagram illustrating an example of controlling a light emitting region and a light receiving region of a camera system according to a second embodiment.

FIG. 5 is a diagram illustrating an example of controlling a light emission interval and light emission intensity of a camera system according to a third embodiment.

FIG. 6 is a diagram illustrating a control example of a continuous light emission count of a camera system according to a fourth embodiment.

FIG. 7 is a diagram illustrating an example of controlling a light emission pulse width of a camera system according to a fifth embodiment.

FIG. 8 is a diagram illustrating an example of controlling a light emission position and a light reception position of a camera system according to a sixth embodiment.

FIG. 9 is a diagram illustrating a display example of a target object to be autofocused in a camera system according to a seventh embodiment.

FIG. 10 is a diagram illustrating an example of a distance measurement environment of a target object to be autofocused in a camera system according to an eighth embodiment.

FIG. 11 is a diagram illustrating an example of distance measurement processing of the camera system according to the eighth embodiment.

FIG. 12 is a diagram illustrating a relationship between a distance and a correction value used for distance measurement processing of the camera system according to the eighth embodiment.

FIG. 13 is a flowchart illustrating an example of distance measurement processing of the camera system according to the eighth embodiment.

FIG. 14 is a flowchart illustrating an example of autofocus control of a camera system according to a ninth embodiment.

FIG. 15 is a diagram illustrating an example of controlling a light emitting region and a light receiving region of a camera system according to a 10th embodiment.

FIG. 16 is a flowchart illustrating an example of control of a light emitting region and a light receiving region of the camera system according to the 10th embodiment.

FIG. 17 is a diagram illustrating a first example of a distance measurement environment of a target object to be autofocused in a camera system according to an 11th embodiment.

FIG. 18 is a diagram illustrating an example of a histogram in the first example of the distance measurement environment of the camera system according to the 11th embodiment.

FIG. 19 is a diagram illustrating a second example of a distance measurement environment of a target object to be autofocused in the camera system according to the 11th embodiment.

FIG. 20 is a diagram illustrating an example of a histogram in a second example of the distance measurement environment of the camera system according to the 11th embodiment.

FIG. 21 is a flowchart illustrating an example of autofocus control of the camera system according to the 11th embodiment.

FIG. 22 is a block diagram depicting a schematic configuration example of a vehicle control system.

FIG. 23 is a diagram of assistance in explaining an example of installation positions of an imaging section.

### MODE FOR CARRYING OUT THE INVENTION

Modes for carrying out the present technology (hereinafter, referred to as embodiments) will be described below. The description will be given in the following order.
1. First Embodiment (Example of Performing Autofocus Control in Accordance With Distance Measurement Result Measured on Basis of Predicted Position of Target Object)
2. Second Embodiment (Example of Controlling Light Emitting Region and Light Receiving Region on Basis of Predicted Position of Target Object)
3. Third Embodiment (Example of Controlling Light Emission Interval and Light Emission Intensity on Basis of Predicted Position of Target Object)
4. Fourth Embodiment (Example of Controlling Continuous Light Emission Count on Basis of Predicted Position of Target Object)
5. Fifth Embodiment (Example of Controlling Light Emission Pulse Width on Basis of Predicted Position of Target Object)
6. Sixth Embodiment (Example of Adding Margin to Light Emission Position and Light Reception Position Controlled on Basis of Predicted Position of Target Object)
7. Seventh Embodiment (Example of Displaying Target Object to Be Autofocused on Basis of Predicted Position of Target Object)
8. Eighth Embodiment (Example of Correcting Distance Measurement Result When There Is Transparent Body in Front of Target Object to Be Measured)
9. Ninth Embodiment (Example of Autofocus Control According to Distance Measurement Result of Target Object Recognized on Basis of Phase Difference Autofocus)
10. 10th Embodiment (Example of Expanding Light Emission Range and Light Reception Range Controlled on Basis of Predicted Position of Target Object on Basis of Recognition Result of Target Object)
11. 11th Embodiment (Example of Autofocus Control When There Is Another Object in Front of Target Object to Be Measured)
12. Application Example to Mobile Body

### 1. First Embodiment

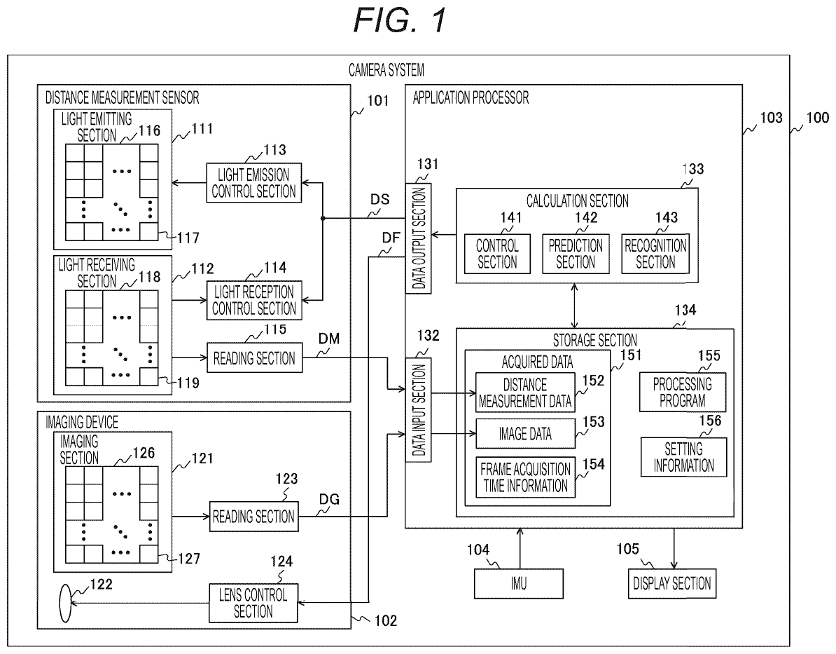

FIG. 1 is a block diagram illustrating a configuration example of a camera system according to a first embodiment.

In the drawing, a camera system 100 performs autofocus control according to a distance measurement result measured on the basis of the predicted position of the target object. At this time, in order to predict the position of the target object to be autofocused, the camera system 100 can calculate a three-dimensional motion vector of the target object on the basis of the distance measurement data DM and the image data DG. Note that the image data DG may be RGB image data or infrared image data. The camera system 100 includes a distance measurement sensor 101, an imaging device 102, an application processor 103, an inertial measurement unit (IMU) 104, and a display section 105.

The distance measurement sensor 101 generates distance measurement data DM on the basis of the distance measurement to the target object. The distance measurement sensor 101 is, for example, a time of flight (ToF) sensor. The distance measurement sensor 101 includes a light emitting section 111, a light receiving section 112, a light emission control section 113, a light reception control section 114, and a reading section 115.

The light emitting section 111 generates distance measurement light with which a target object is irradiated. The wavelength range of the distance measurement light may be a visible range or an infrared range. The light emitting section 111 includes a light emission array section 116. The light emission array section 116 includes a plurality of light emitting regions 117. The light emitting regions 117 may be arranged in a matrix in the row direction and the column direction. Each light emitting region 117 can emit light individually. Each light emitting region 117 may include a laser element.

The light receiving section 112 receives reflected light from the target object irradiated with the distance measurement light. The light receiving section 112 includes a light receiving array section 118. The light receiving array section 118 includes a plurality of light receiving regions 119. The light receiving regions 119 may be arranged in a matrix in the row direction and the column direction. Each light receiving region 119 can receive light individually. Each light receiving region 119 may include a single photon avalanche diode (SPAD).

In addition, the light receiving section 112 may include a time to digital converter (TDC) and a histogram generation section. The histogram generation section can indicate a relationship between a time difference from light emission to light reception and the reaction count in each light receiving region 119.

The light emission control section 113 controls light emission of the light emitting section 111 on the basis of the distance measurement control information DS. For example, the light emission control section 113 can control the light emission interval, the light emission intensity, the light emission position, the continuous light emission count, and the light emission pulse width of the light emitting section 111 on the basis of the distance measurement control information DS. In the control of the light emission position of the light emitting section 111, the light emitting region 117 to be activated can be selected.

The light reception control section 114 controls the light reception of the light receiving section 112 on the basis of the distance measurement control information DS. For example, the light reception control section 114 can control the light reception position of the light receiving section 112 on the basis of the distance measurement control information DS. In the control of the light reception position of the light receiving section 112, the light receiving region 119 to be activated can be selected.

The reading section 115 reads the distance measurement data DM of each light receiving region 119 from the light receiving array section 118, and outputs the distance measurement data DM to the application processor 103.

The imaging device 102 generates image data DG on the basis of imaging of an imaging range including a distance measurement position of a target object. The imaging device 102 includes an imaging section 121, an optical system 122, a reading section 123, and a lens control section 124.

The imaging section 121 performs imaging of an imaging range including a distance measurement position of a target object. The imaging section 121 includes a pixel array section 126. The pixel array section 126 includes a plurality of pixels 127. The pixels 127 may be arranged in a matrix in the row direction and the column direction. Each pixel 127 may comprise a photodiode and a pixel transistor.

The optical system 122 forms an image of the incident light on the light receiving surface of the imaging section 121. Note that the optical system 122 may include a lens, an optical filter, a diaphragm, and the like.

The reading section 123 reads the image data DG from the pixel array section 126 and outputs the image data DG to the application processor 103. The image data DG can be configured on the basis of the pixel data read from each pixel 127.

The lens control section 124 performs focus control of the light received by the imaging section 121 by controlling the position of the optical system 122 on the basis of the focus control information DF.

The application processor 103 generates the focus control information DF of the imaging device 102 and the distance measurement control information DS of the distance measurement sensor 101 on the basis of the distance measurement data DM and the image data DG. The distance measurement control information DS can include at least any one of the light emission interval, the light emission intensity, the light emission position, the continuous light emission count, the light emission pulse width, or the light reception position of the distance measurement sensor 101. The application processor 103 includes a data output section 131, a data input section 132, a calculation section 133, and a storage section 134.

The data output section 131 outputs the distance measurement control information DS to the distance measurement sensor 101 and outputs the focus control information DF to the imaging device 102. The distance measurement control information DS and the focus control information DF output via the data output section 131 can be input from the calculation section 133 to the data output section 131.

The data input section 132 inputs the distance measurement data DM output from the distance measurement sensor 101 and the image data DG output from the imaging device 102. The distance measurement data DM and the image data DG input via the data input section 132 can be stored in the storage section 134.

The calculation section 133 generates the distance measurement control information DS and the focus control information DF on the basis of the distance measurement data DM and the image data DG. The calculation section 133 can access the storage section 134, store the calculation result of the calculation section 133 in the storage section 134, and read data from the storage section 134. The calculation section 133 includes a control section 141, a prediction section 142, and a recognition section 143.

The control section 141 performs light emission control of the distance measurement sensor 101, light reception control of the distance measurement sensor 101, and focus control of the imaging device 102. For example, the control section 141 can perform focus control of the imaging device 102 on the basis of a three-dimensional predicted position of the target object. Furthermore, the control section 141 can control at least any one of the light emission interval, the light emission intensity, the light emission position, the continuous light emission count, the light emission pulse width, or the light reception position of the distance measurement sensor 101 on the basis of the three-dimensional predicted position of the target object.

The prediction section 142 predicts the three-dimensional position of the target object on the basis of the distance measurement data DM and the image data DG. The prediction section 142 can calculate a three-dimensional motion vector of the target object on the basis of the distance measurement data DM and the image data DG in order to predict the three-dimensional position of the target object. At this time, the prediction section 142 can predict the three-dimensional position of the target object of the next frame from the distance measurement data DM and the image data DG of a plurality of frames.

The recognition section 143 performs object recognition of a target object on the basis of the image data DG generated by the imaging device 102. In the object recognition of the target object, the recognition section 143 can recognize the shape, pattern, and color of the target object.

The storage section 134 stores various data related to distance measurement and imaging. The storage section 134 may include a semiconductor memory such as a static random access memory (SRAM) or a dynamic random access memory (DRAM), or may include a storage device such as a hard disk device or a solid state drive (SSD).

The storage section 134 stores acquired data 151, a processing program 155, and setting information 156. The acquired data 151 includes distance measurement data 152, image data 153, and frame acquisition time information 154. The processing program 155 includes a program executed by the application processor 103. The setting information 156 includes setting information used for distance measurement and imaging.

The IMU 104 detects three-dimensional inertial motion (three-axis translational and rotational motion). The IMU 104 may comprise, for example, an acceleration sensor, a rotational angular acceleration sensor, a gyro sensor, a magnetic field sensor, an atmospheric pressure sensor, or a temperature sensor.

The display section 105 displays a target object to be measured in distance, a three-dimensional motion vector of the target object to be measured in distance, a distance image, a user interface screen, and the like. The display section 105 may be a liquid crystal display device or an organic EL display device. At this time, the application processor 103 can output the target object to be measured and the display control information of the three-dimensional motion vector of the target object to be measured to the display section 105.

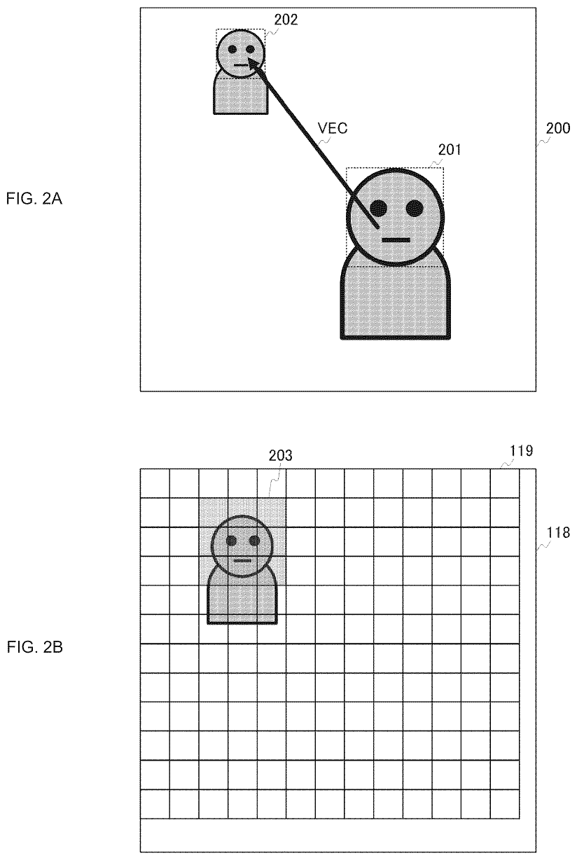

FIG. 2 is a diagram illustrating an example of prediction of a three-dimensional motion vector of a target object in the camera system according to the first embodiment.

Referring to a in the drawing, the imaging device 102 generates a two-dimensional image 200. At this time, the prediction section 142 predicts the three-dimensional position of the target object 202 in the next frame on the basis of the distance measurement data DM and the image data DG of the target object 201 in a plurality of past frames. In the prediction of the three-dimensional position of the target object 202, the prediction section 142 can calculate the three-dimensional motion vector VEC from the target object 201 to the target object 202 on the basis of the distance measurement data DM and the image data DG of the target object 201 in a plurality of past frames.

Next, as illustrated in b of the drawing, the control section 141 sets the light reception range 203 of the next frame on the basis of the predicted position of the target object 202 of the next frame. At this time, the control section 141 activates the light receiving region 119 included in the light reception range 203. As a result, the light receiving region 119 outside the light reception range 203 can be deactivated while enabling the distance measurement of the target object 202 of the next frame, and the power consumption can be reduced without deteriorating the distance measurement accuracy.

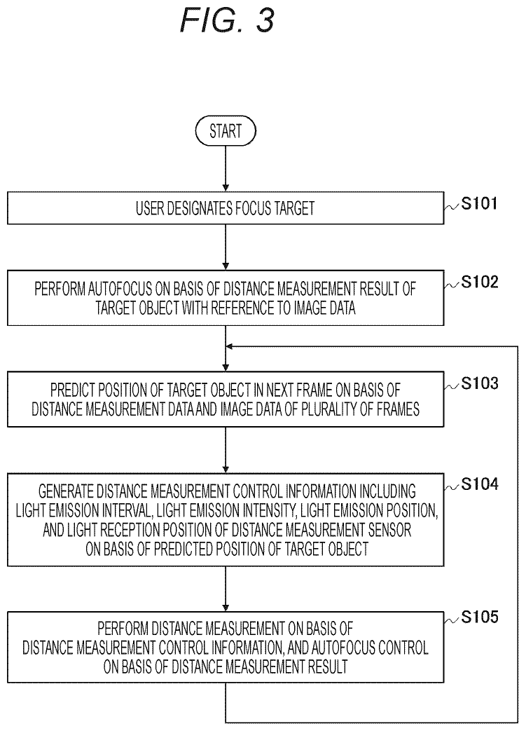

FIG. 3 is a flowchart illustrating an example of autofocus control of the camera system according to the first embodiment.

In the drawing, the user designates the target object to be focused (S101). In the designation of the target object, for example, the target object may be touched on the display screen of the display section 105.

Next, the camera system 100 refers to the image data DG and performs autofocus of the imaging device 102 on the basis of the distance measurement data DM of the target object (S102). In the reference to the image data DG, the camera system 100 can confirm whether or not the target object is within the angle of view of the imaging device 102 or whether or not there is an obstacle in front of the target object.

Next, the camera system 100 predicts the three-dimensional position of the target object 202 in the next frame on the basis of the distance measurement data DM and the image data DG of the target object 201 in a plurality of past frames (S103).

Next, the camera system 100 generates distance measurement control information DS including at least any one of the light emission interval, the light emission intensity, the light emission position, the continuous light emission count, the light emission pulse width, or the light reception position of the distance measurement sensor 101 (S104).

Next, the camera system 100 performs distance measurement of the target object on the basis of the distance measurement control information DS, and performs autofocus of the imaging device 102 on the basis of the distance measurement data DM of the target object obtained by the distance measurement (S105). In the autofocus of the imaging device 102, the application processor 103 can output the focus control information DF to the imaging device 102.

As described above, in the above-described first embodiment, the camera system 100 performs autofocus control according to the distance measurement result obtained by distance measurement on the basis of the predicted position of the target object. As a result, it is possible to perform autofocus on the basis of the distance measurement range three-dimensionally optimized on the basis of the position of the target object and the distance to the target object, and it is possible to reduce power consumption without deteriorating focus accuracy.

### 2. Second Embodiment

In the first embodiment described above, autofocus is performed on the basis of the distance measurement result obtained from the light reception range 203 set on the basis of the predicted position of the target object of the next frame. In the second embodiment, a light emission range and a light reception range are set on the basis of a predicted position of a target object of a next frame, and autofocus is performed on the basis of a distance measurement result obtained from the setting.

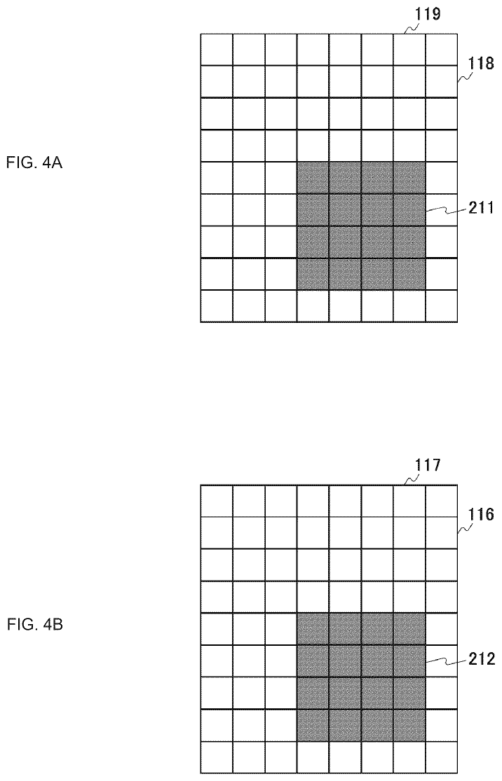

FIG. 4 is a diagram illustrating a control example of the light emitting region and the light receiving region of the camera system according to the second embodiment.

In the drawing, the prediction section 142 predicts the three-dimensional position of the target object of the next frame on the basis of the distance measurement data DM and the image data DG of the target object of a plurality of past frames.

Next, as illustrated in a of the drawing, the control section 141 sets the light reception range 211 of the next frame on the basis of the predicted position of the target object of the next frame. The light reception range 211 may include a light reception position of the reflected light from the predicted position of the target object of the next frame. At this time, the control section 141 activates the light receiving region 119 included in the light reception range 211.

Furthermore, as illustrated in b of the drawing, the control section 141 sets the light emission range 212 of the next frame on the basis of the predicted position of the target object of the next frame. The light emission range 212 may include a light emission position of the distance measurement light with which the predicted position of the target object of the next frame is irradiated. At this time, the control section 141 activates the light emitting region 117 included in the light emission range 212.

As described above, in the above-described second embodiment, the camera system 100 sets the light reception range 211 and the light emission range 212 on the basis of the predicted position of the target object of the next frame, and performs autofocus on the basis of the distance measurement result according to the setting. As a result, while the distance measurement range is limited on the basis of the position of the target object and the distance to the target object, autofocus can be performed on the basis of the distance measurement result accompanied by the limitation, and the power consumption can be reduced without deteriorating the focus accuracy.

### 3. Third Embodiment

In the second embodiment described above, the light reception range 211 and the light emission range 212 are set on the basis of the predicted position of the target object of the next frame, and autofocus is performed on the basis of the distance measurement result according to the setting. In the third embodiment, the light emission interval and the light emission intensity of the distance measurement sensor 101 are set on the basis of the predicted position of the target object of the next frame, and autofocus is performed on the basis of the distance measurement result according to the setting.

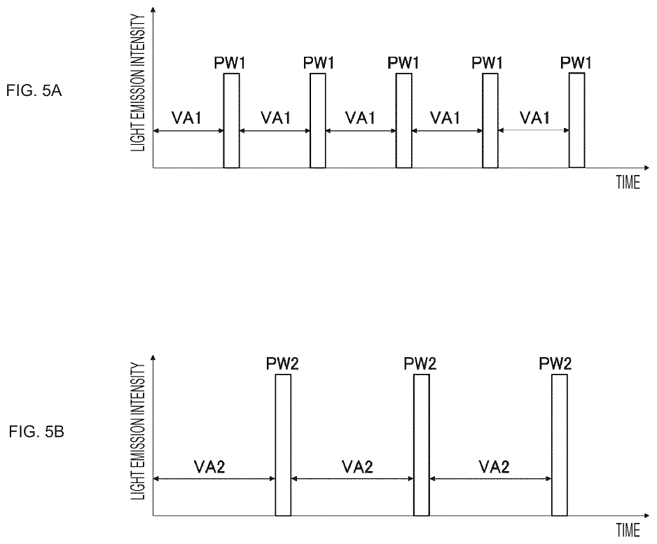

FIG. 5 is a diagram illustrating a control example of the light emission interval and the light emission intensity of the camera system according to the third embodiment.

In the drawing, the prediction section 142 predicts the three-dimensional position of the target object of the next frame on the basis of the distance measurement data DM and the image data DG of the target object of a plurality of past frames.

Next, as illustrated in a of the drawing, the control section 141 sets the light emission interval VA1 and the light emission intensity PW1 of the next frame on the basis of the predicted position of the target object of the next frame. At this time, in a case where the distance measurement target is a short distance, the control section 141 can reduce the light emission interval VAI and the light emission intensity PW1.

Here, in a case where the distance measurement target is a short distance, since attenuation of reflected light from the target object is small, the light emission intensity PW1 of the light emitting section 111 may be small. In addition, in a case where the distance measurement target is a short distance, the light emission interval VAI of the light emitting section 111 may be short because the arrival timing of the reflected light from the target object is early and the number of bins of the histogram used in the distance measurement is small.

Furthermore, as illustrated in b of the drawing, the control section 141 sets the light emission interval VA2 and the light emission intensity PW2 of the next frame on the basis of the predicted position of the target object of the next frame. At this time, in a case where the distance measurement target is a long distance, the control section 141 can increase the light emission interval VA2 and the light emission intensity PW2.

As described above, in the above-described third embodiment, the camera system 100 sets the light emission interval and the light emission intensity on the basis of the predicted position of the target object in the next frame, and performs autofocus on the basis of the distance measurement result according to the setting. As a result, it is possible to perform autofocus on the basis of the optimized distance measurement result while optimizing the distance measurement condition on the basis of the position of the target object and the distance to the target object, and it is possible to reduce power consumption without deteriorating focus accuracy.

### 4. Fourth Embodiment

In the third embodiment described above, the light emission interval and the light emission intensity of the distance measurement sensor 101 are set on the basis of the predicted position of the target object in the next frame, and autofocus is performed on the basis of the distance measurement result according to the setting. In the fourth embodiment, the continuous light emission count of the distance measurement sensor 101 is set on the basis of the predicted position of the target object of the next frame, and autofocus is performed on the basis of the distance measurement result according to the setting.

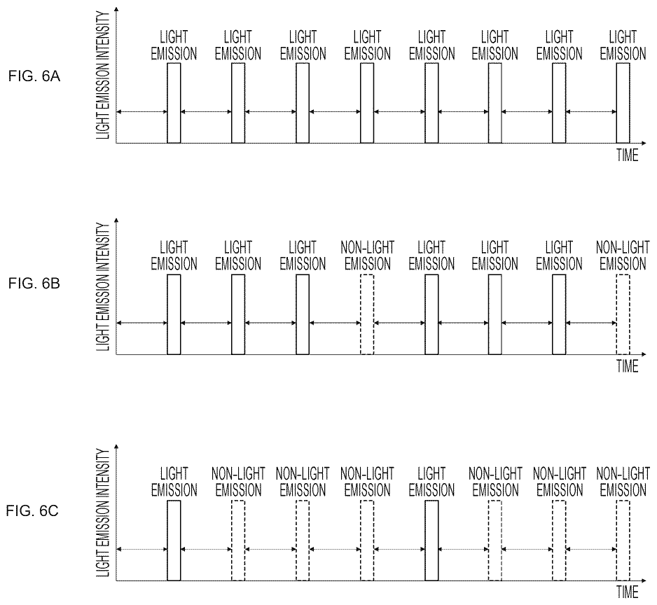

FIG. 6 is a diagram illustrating a control example of the continuous light emission count of the camera system according to the fourth embodiment.

In the drawing, the prediction section 142 predicts the three-dimensional position of the target object of the next frame on the basis of the distance measurement data DM and the image data DG of the target object of a plurality of past frames. At this time, in order to improve the S/N ratio, the control section 141 can increase the continuous light emission count as the predicted position of the target object becomes longer.

For example, in a case where the distance measurement target is a long distance, the control section 141 sets the continuous light emission count to 8 as illustrated in a of the drawing.

Furthermore, for example, in a case where the distance measurement target is a middle distance, the control section 141 sets the continuous light emission count to 3 as illustrated in b of the drawing.

Furthermore, for example, in a case where the distance measurement target is a short distance, the control section 141 sets the continuous light emission count to 1 as illustrated in c of the drawing.

As described above, in the above-described fourth embodiment, the camera system 100 sets the continuous light emission count on the basis of the predicted position of the target object in the next frame, and performs autofocus on the basis of the distance measurement result according to the setting. As a result, it is possible to perform autofocus on the basis of the optimized distance measurement result while optimizing the distance measurement condition on the basis of the position of the target object and the distance to the target object, and it is possible to reduce power consumption without deteriorating focus accuracy.

### 5. Fifth Embodiment

In the above-described fourth embodiment, the continuous light emission count of the distance measurement sensor 101 is set on the basis of the predicted position of the target object of the next frame, and autofocus is performed on the basis of the distance measurement result according to the setting. In the fifth embodiment, the light emission pulse width of the distance measurement sensor 101 is set on the basis of the predicted position of the target object of the next frame, and autofocus is performed on the basis of the distance measurement result according to the setting.

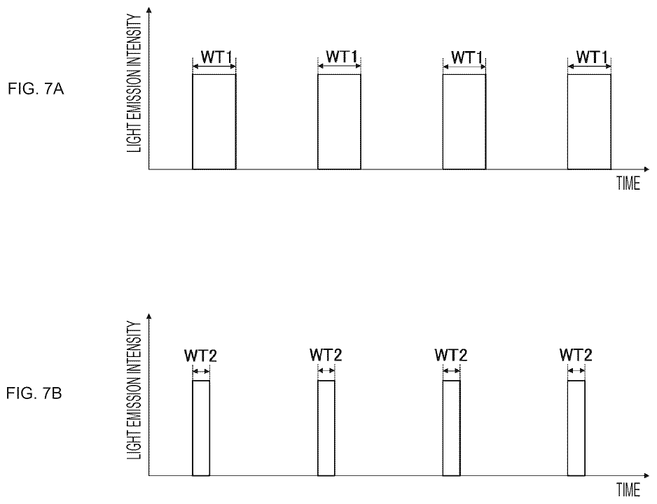

FIG. 7 is a diagram illustrating a control example of the light emission pulse width of the camera system according to the fifth embodiment.

In the drawing, the prediction section 142 predicts the three-dimensional position of the target object of the next frame on the basis of the distance measurement data DM and the image data DG of the target object of a plurality of past frames. At this time, as the predicted position of the target object becomes longer, the time width for one bin of the histogram used for distance measurement may increase. At this time, in order to ensure the distance measurement accuracy, the control section 141 can increase the light emission pulse width of the light emitting section 111 in accordance with an increase in the time width for one bin of the histogram. Here, in a case where the light emission pulse width >the histogram bin, the distance measurement accuracy equal to or less than the time resolution of the histogram bin can be acquired on the basis of the centroid calculation of the counts of the plurality of bins.

For example, in a case where the distance measurement target is a long distance, the control section 141 widely sets the light emission pulse width WT1 of the next frame on the basis of the predicted position of the target object of the next frame as illustrated in a of the drawing.

Furthermore, in a case where the distance measurement target is a short distance, the control section 141 sets the light emission pulse width WT2 of the next frame to be narrow on the basis of the predicted position of the target object of the next frame as illustrated in b of the drawing. At this time, the control section 141 can make the light emission pulse width WT2 smaller than the light emission pulse width WT1.

As described above, in the above-described fifth embodiment, the camera system 100 sets the light emission pulse width on the basis of the predicted position of the target object in the next frame, and performs autofocus on the basis of the distance measurement result according to the setting. As a result, it is possible to perform autofocus on the basis of the optimized distance measurement result while optimizing the distance measurement condition on the basis of the position of the target object and the distance to the target object, and it is possible to reduce power consumption without deteriorating focus accuracy.

### 6. Sixth Embodiment

In the first embodiment described above, autofocus is performed on the basis of the distance measurement result obtained from the light reception range 203 set on the basis of the predicted position of the target object of the next frame. In the sixth embodiment, a margin is provided in the light reception range 203 and the light emission range 212 set on the basis of the predicted position of the target object of the next frame.

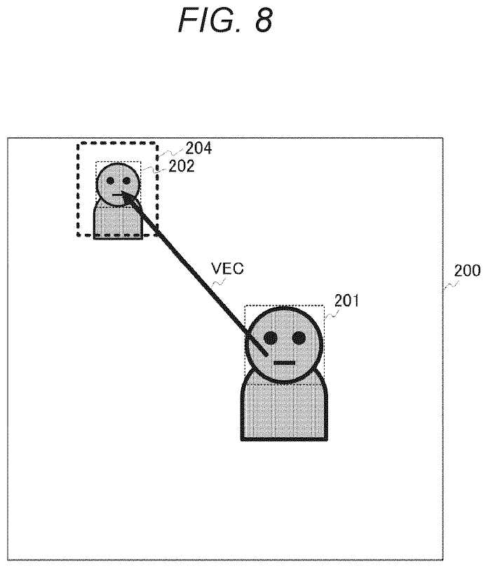

FIG. 8 is a diagram illustrating an example of controlling a light emission position and a light reception position of the camera system according to the sixth embodiment.

In the drawing, the prediction section 142 predicts the three-dimensional position of the target object 202 of the next frame on the basis of the distance measurement data DM and the image data DG of the target object 201 of a plurality of past frames. At this time, the prediction section 142 can set the prediction range 204 obtained by adding a margin to the predicted position of the target object 202.

Next, the control section 141 sets the light reception range 203 and the light emission range 212 of the next frame on the basis of the prediction range 204 of the target object 202 to which the margin is added. Furthermore, the control section 141 can set the light emission interval and the light emission intensity on the basis of the prediction range 204 of the target object 202 to which the margin is added. For example, the control section 141 can set the light emission interval and the light emission intensity so as to correspond to a distance of 1.2 times the predicted position in the depth direction of the target object 202.

As described above, in the above-described sixth embodiment, the camera system 100 provides a margin in the light reception range 203 and the light emission range 212 set on the basis of the predicted position of the target object of the next frame. As a result, it is possible to give a margin to the distance measurement condition optimized on the basis of the position of the target object and the distance to the target object, and it is possible to improve the stability of the focus control while reducing the power consumption.

### 7. Seventh Embodiment

In the first embodiment described above, in order to predict the position of the target object to be autofocused, the three-dimensional motion vector of the target object is calculated on the basis of the distance measurement data DM and the image data DG. In the seventh embodiment, a target object moving according to a three-dimensional motion vector calculated on the basis of distance measurement data DM and image data DG can be displayed.

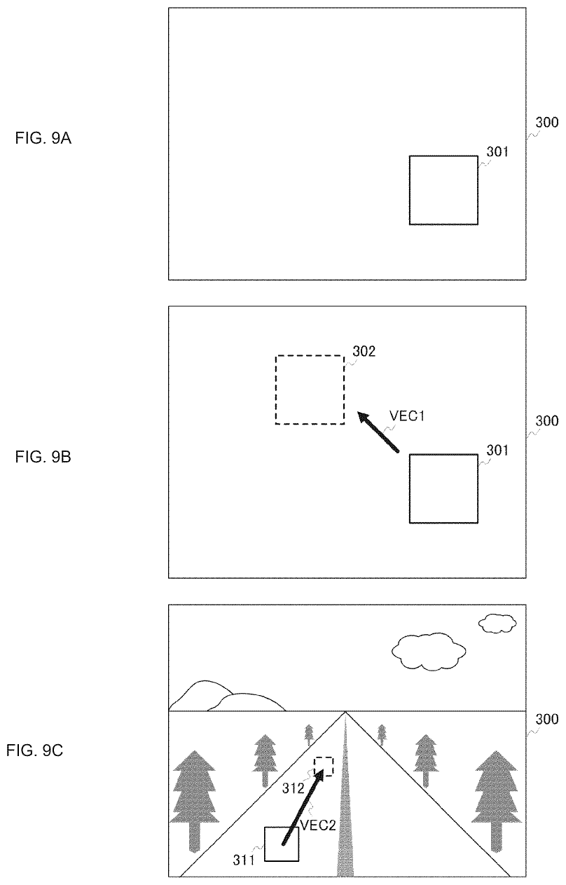

FIG. 9 is a diagram illustrating a display example of a target object to be autofocused in the camera system according to the seventh embodiment.

In the drawing, the display section 105 includes a display screen 300. At this time, the target object 301 to be autofocused is displayed on the display screen 300 as illustrated in a of the drawing. This target object 301 may be emphasized on the display screen 300. In the emphasized display of the target object 301, the captured image of the target object to be autofocused may be surrounded by a frame.

In addition, as illustrated in b of the drawing, the target object 301 to be autofocused and its predicted position 302 are displayed on the display screen 300. In addition, the three-dimensional motion vector VEC1 indicating the predicted position 302 of the target object 301 to be autofocused and the moving speed may be displayed on the display screen 300.

Furthermore, on the display screen 300, as illustrated in c of the drawing, the target object 311 to be autofocused and its predicted position 312 may be displayed in a three-dimensional virtual space. The three-dimensional virtual space may be a captured image of the target object 311 and the periphery of the predicted position 312, or the target object 311 and the periphery of the predicted position 312 may be three-dimensionally illustrated, or may be a metaverse. Furthermore, the target object 311 to be autofocused and its predicted position 312 may be displayed as an animation in a three-dimensional virtual space. In addition, the three-dimensional motion vector VEC2 indicating the predicted position 312 of the target object 311 to be autofocused and the moving speed may be displayed on the three-dimensional virtual space.

As described above, in the seventh embodiment described above, it is possible to display the target object moving according to the three-dimensional motion vector calculated on the basis of the distance measurement data DM and the image data DG. As a result, the target object to be autofocused can be visually recognized on the screen while moving in the three-dimensional space.

### 8. Eighth Embodiment

In the first embodiment described above, the distance measurement condition is set on the basis of the predicted position of the target object of the next frame, and autofocus is performed on the basis of the distance measurement result according to the distance measurement condition. In the eighth embodiment, a distance measurement result when there is a transparent body in front of a target object to be measured is corrected.

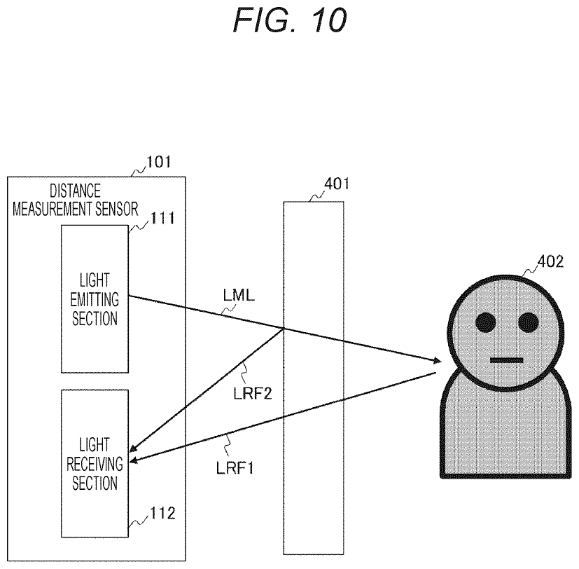

FIG. 10 is a diagram illustrating an example of a distance measurement environment of an autofocus target object of the camera system according to the eighth embodiment.

In the drawing, it is assumed that there is a transparent body 401 in front of the target object 402 to be autofocused. The transparent body 401 is, for example, a glass plate such as a window. At this time, the distance measurement light LML emitted from the light emitting section 111 is transmitted through the transparent body 401 and applied to the target object 402, and the reflected light LRF1 reflected by the target object 402 is incident on the light receiving section 112 via the transparent body 401. In addition, the distance measurement light LML emitted from the light emitting section 111 is reflected by the transparent body 401, and the reflected light LRF2 reflected by the transparent body 401 is incident on the light receiving section 112. At this time, since the transparent body 401 is closer to the distance measurement sensor 101 than the target object 402, the intensity of the reflected light LRF2 may be stronger than the intensity of the reflected light LRF1. As a result, if the distance from the peak position of the histogram of the SPAD reaction count based on the reception of each of the reflected lights LRF1 and LRF2 to the target object 402 is obtained, erroneous distance measurement may be caused.

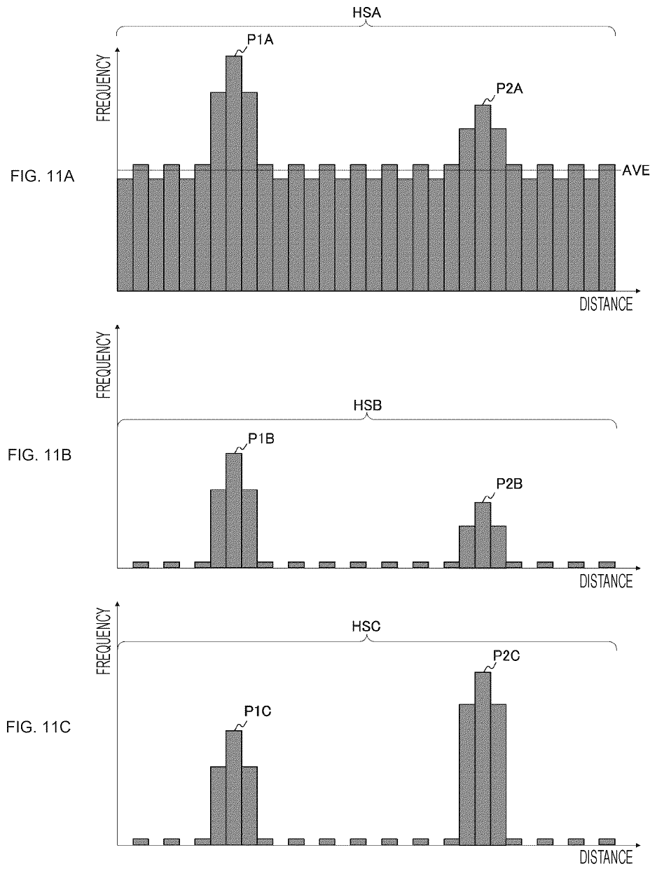

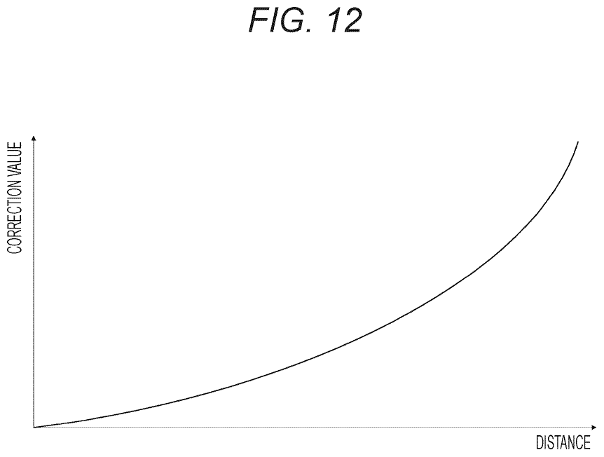

FIG. 11 is a diagram illustrating an example of distance measurement processing of the camera system according to the eighth embodiment, and FIG. 12 is a diagram illustrating a relationship between a distance and a correction value used for the distance measurement processing of the camera system according to the eighth embodiment.

In a of FIG. 11, when receiving the reflected lights LRF1 and LRF2 from the target object 402 and the transparent body 401, the distance measurement sensor 101 generates a histogram HSA of the SPAD reaction count based on the reception of the reflected lights LRF1 and LRF2.

In the histogram HSA, a peak P1A of the SPAD reaction count based on the reception of the reflected light LRF1 from the transparent body 401 and a peak P2A of the SPAD reaction count based on the reception of the reflected light LRF2 from the target object 402 are generated. Since the transparent body 401 is closer to the distance measurement sensor 101 than the target object 402, the height of the peak P1A is higher than the height of the peak P2A. At this time, the distance measurement sensor 101 refers to the image data DG including the target object 402 in the imaging range. Then, in a case where the existence of another target object in front of the target object 402 cannot be confirmed from the image data DG, the application processor 103 can determine that the transparent body 401 corresponding to the peak P1A is in front of the target object 402.

When determining that there is a transparent body 401 in front of the target object 402, the application processor 103 performs background light processing. In the background light processing, the application processor 103 calculates an average count value AVE of all the bins of the histogram HSA. Then, the application processor 103 subtracts the average count value AVE from the histogram HSA and generates a histogram HSB as illustrated in b of FIG. 11. In the histogram HSB, the peak PIB corresponding to the transparent body 401 is generated at a position at the same distance as the peak P1A, and the peak P2B corresponding to the target object 402 is generated at a position at the same distance as the peak P2A.

Next, the application processor 103 corrects the histogram HSB on the basis of the correction value depending on the distance from the distance measurement sensor 101, and generates the histogram HSC as illustrated in c of FIG. 11. The correction value depending on the distance from the distance measurement sensor 101 can be given by a non-linear function using the distance as a parameter. At this time, the light intensity attenuates by the square of the distance from the distance measurement sensor 101. Therefore, for example, as illustrated in FIG. 12, as the correction value depending on the distance from the distance measurement sensor 101, a correction value proportional to the square of the distance corresponding to each bin of the histogram HSB can be used.

In the histogram HSC, the peak PIC corresponding to the transparent body 401 is generated at a position at the same distance as the peak P1B, and the peak P2C corresponding to the target object 402 is generated at a position at the same distance as the peak P2B. At this time, the height of the peak PIC corresponding to the transparent body 401 is lower than the height of the peak P2C corresponding to the target object 402. Therefore, the distance measurement sensor 101 can calculate the distance to the target object 402 on the basis of the position of the peak P2C of the histogram HSC.

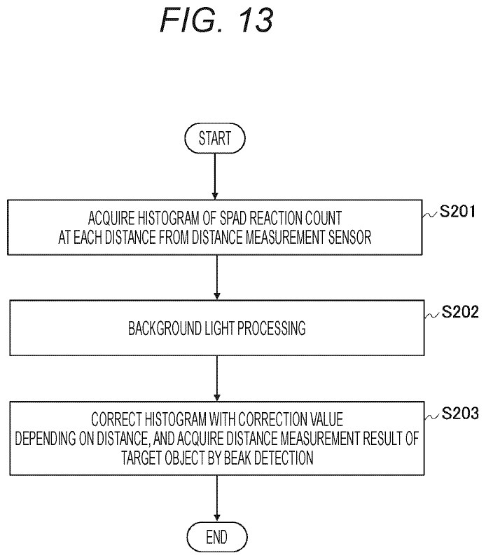

FIG. 13 is a flowchart illustrating an example of distance measurement processing of the camera system according to the eighth embodiment.

In the drawing, the application processor 103 acquires a histogram of the SPAD reaction count for each distance from the distance measurement sensor 101 (S201). At this time, the application processor 103 can cause the distance from the distance measurement sensor 101 to correspond to the position of the bin of the histogram.

Next, the application processor 103 performs background light processing on the histogram acquired in S201 (S202). In the background light processing, the histogram average count value may be subtracted from the histogram.

Next, the application processor 103 corrects the histogram after the background light processing on the basis of the correction value depending on the distance from the distance measurement sensor 101. Then, the application processor 103 acquires the distance measurement result of the target object on the basis of the peak detection of the corrected histogram (S203).

As described above, in the above-described eighth embodiment, the histogram when the transparent body 401 is in front of the target object 402 to be measured in distance is corrected on the basis of the correction value depending on the distance from the distance measurement sensor 101. As a result, it is possible to improve the distance measurement accuracy when the transparent body 401 exists in front of the target object 402 to be measured in distance.

### 9. Ninth Embodiment

In the first embodiment described above, autofocus control of a target object to be subjected to autofocus control is performed on the basis of a distance measurement result of the target object. In the ninth embodiment, autofocus control is performed according to a distance measurement result of a target object recognized on the basis of phase difference autofocus.

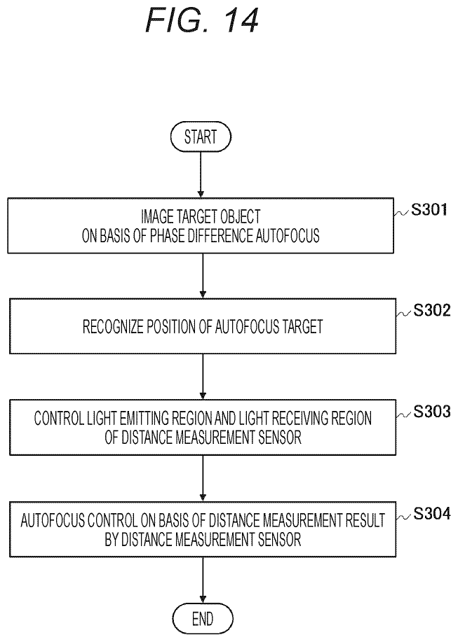

FIG. 14 is a flowchart illustrating an example of autofocus control of the camera system according to the ninth embodiment.

In the drawing, the camera system 100 captures an image of the target object on the basis of the phase difference autofocus (S301). The imaging range of the target object can be set to the entire angle of view. Here, the power consumption of imaging in which the entire angle of view is set to the imaging range can be made smaller than the power consumption of distance measurement in which the entire angle of view is set to the distance measurement range.

Next, the application processor 103 recognizes the position of the autofocus target on the basis of the target object imaged on the basis of the phase difference autofocus (S302).

Next, the application processor 103 controls the light emission position and the light reception position of the distance measurement sensor 101 on the basis of the position of the autofocus target (S303). At this time, by limiting the light emission position and the light reception position of the distance measurement sensor 101 on the basis of the position of the autofocus target, power consumption can be reduced as compared with a case where the entire angle of view is set to the distance measurement range.

Next, the camera system 100 performs autofocus of the imaging device 102 on the basis of the distance measurement result by the distance measurement sensor 101 (S304).

As described above, in the ninth embodiment described above, the autofocus control of the target object is performed according to the distance measurement result of the target object recognized on the basis of the phase difference autofocus. As a result, it is not necessary to perform distance measurement of the entire angle of view in order to recognize the position of the autofocus target, and it is possible to switch to distance measurement of the target object after recognizing the position of the autofocus target. Therefore, it is possible to reduce power consumption without deteriorating focus accuracy.

### 10. 10th Embodiment

In the second embodiment described above, the light emission position and the light reception position of the distance measurement sensor 101 are controlled on the basis of the predicted position of the target object. In the 10th embodiment, the light emission range and the light reception range controlled on the basis of the predicted position of the target object are expanded on the basis of the recognition result of the target object.

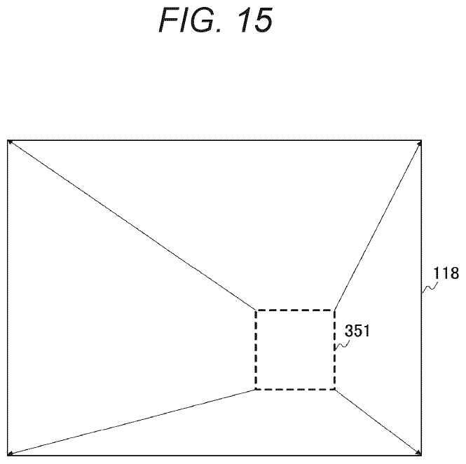

FIG. 15 is a diagram illustrating a control example of the light emitting region and the light receiving region of the camera system according to the 10th embodiment.

In the drawing, the camera system 100 sets the light reception range 351 of the distance measurement sensor 101 in the light receiving array section 118 on the basis of the predicted position of the autofocus target. Then, the camera system 100 measures the distance to the autofocus target while causing the light reception range 351 of the distance measurement sensor 101 to follow the movement of the autofocus target. At this time, the camera system 100 performs object recognition as an autofocus target, and determines whether or not the object recognized as the autofocus target is within the light reception range 351 of the distance measurement sensor 101. Then, in a case where the object recognized as the autofocus target is not within the light reception range 351 of the distance measurement sensor 101, the camera system 100 switches the light reception range to the entire surface of the light receiving array section 118.

Note that, in the drawing, in a case where the object recognized as the autofocus target is not within the light reception range 351 of the distance measurement sensor 101, the light reception range is switched to the entire surface of the light receiving array section 118. In a case where the object recognized as the autofocus target is not within the light emission range of the distance measurement sensor 101, the light emission range may be switched to the entire surface of the light emission array section 116.

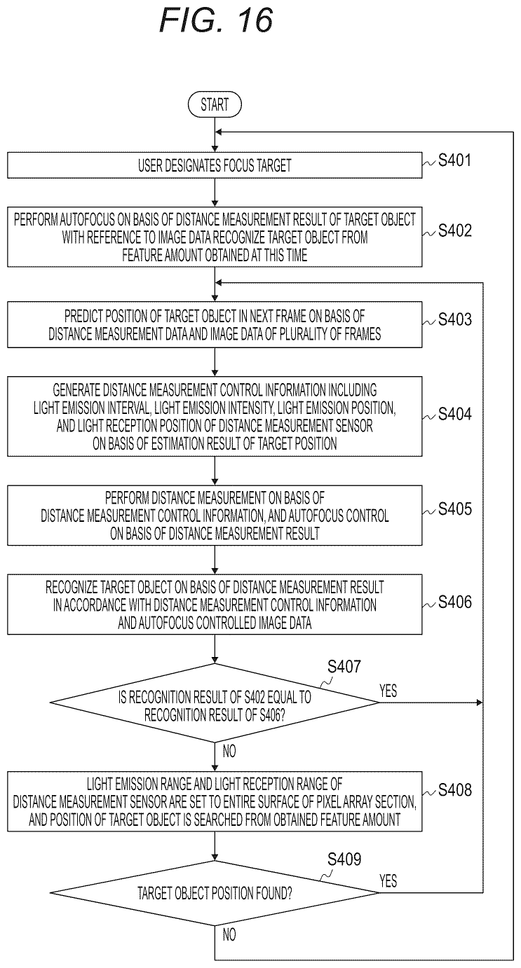

FIG. 16 is a flowchart illustrating an example of control of the light emitting region and the light receiving region of the camera system according to the 10th embodiment.

In the drawing, in the processing of S401 to S405, the camera system 100 performs the processing of S101 to S105 of the first embodiment described above.

Next, the application processor 103 recognizes the target object on the basis of the distance measurement data DM according to the distance measurement control information DS and the image data DG subjected to the autofocus control (S406).

Next, the application processor 103 determines whether the object recognition result in S402 and the object recognition result in S406 are equal to each other (S407). In a case where the object recognition result in S402 is equal to the object recognition result in S406, the application processor 103 returns to the processing in S403. On the other hand, in a case where the object recognition result in S402 and the object recognition result in S406 are not equal to each other, the application processor 103 proceeds to the processing in $408.

At this time, the application processor 103 sets the light emission range and the light reception range of the distance measurement sensor 101 to the entire surface of the pixel array section 126, and searches for the position of the target object from the feature amount obtained at this time (S408).

Next, the application processor 103 determines whether the position of the target object has been found in the entire surface of the pixel array section 126 (S409). In a case where the position of the target object is found in the entire surface of the pixel array section 126, the application processor 103 returns to the processing of S403. On the other hand, in a case where the position of the target object is not found in the entire surface of the pixel array section 126, the application processor 103 returns to the processing of S401.

As described above, in the above-described 10th embodiment, the camera system 100 expands the light emission range and the light reception range controlled on the basis of the predicted position of the autofocus target on the basis of the recognition result of the autofocus target. This makes it possible to perform distance measurement following the autofocus target that has moved beyond the light emission range and the light reception range while limiting the light emission range and the light reception range controlled on the basis of the predicted position of the autofocus target.

### 11. 11th Embodiment

In the above-described 10th embodiment, distance measurement of an autofocus target is performed while following the autofocus target on the basis of a recognition result of the autofocus target. In the 11th embodiment, distance measurement of an autofocus target is performed while confirming the autofocus target on the basis of a recognition result of the autofocus target.

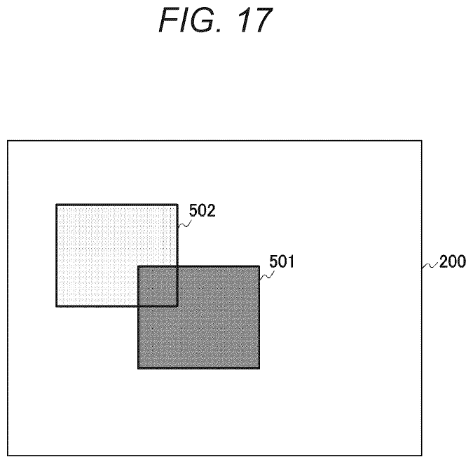

FIG. 17 is a diagram illustrating a first example of a distance measurement environment of a target object to be autofocused in the camera system according to the 11th embodiment.

In the drawing, it is assumed that a distant autofocus target 502 and a neighboring non-autofocus target 501 are illustrated in a two-dimensional image 200 generated by the imaging device 102.

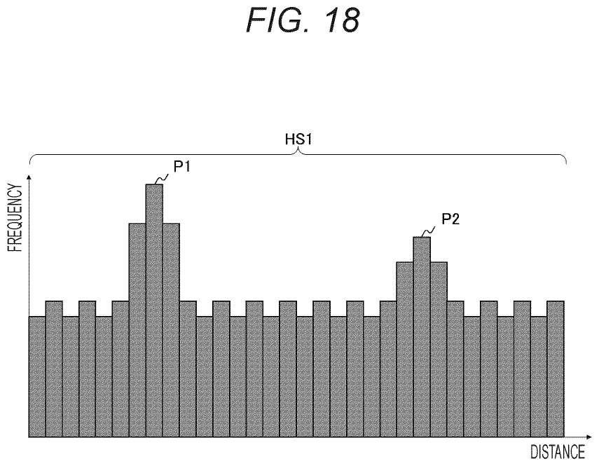

FIG. 18 is a diagram illustrating an example of a histogram in the first example of the distance measurement environment of the camera system according to the 11th embodiment.

In the drawing, the distance measurement sensor 101 generates a histogram HS1 of the SPAD reaction count based on reception of reflected light from a distant autofocus target 502 and a neighboring non-autofocus target 501.

In the histogram HS1, a peak P1 of the SPAD reaction count based on the reception of the reflected light from the neighboring non-autofocus target 501 and a peak P2 of the SPAD reaction count based on the reception of the reflected light from the distant autofocus target 502 are generated. At this time, the height of the peak P1 is higher than the height of the peak P2. Here, calculating the distance to the autofocus target 502 on the basis of the peak detection of the histogram HS1 causes erroneous distance measurement. Therefore, the application processor 103 performs object recognition on the non-autofocus target 501 specified by the peak P1. In a case where the object recognition result of the non-autofocus target 501 specified at the peak P1 does not match the autofocus target 502, the application processor 103 rejects the distance measurement result of the non-autofocus target 501 specified at the peak P1. Then, the application processor 103 performs autofocus control on the autofocus target 502 on the basis of the distance measurement result of the autofocus target 502 specified by the peak P2.

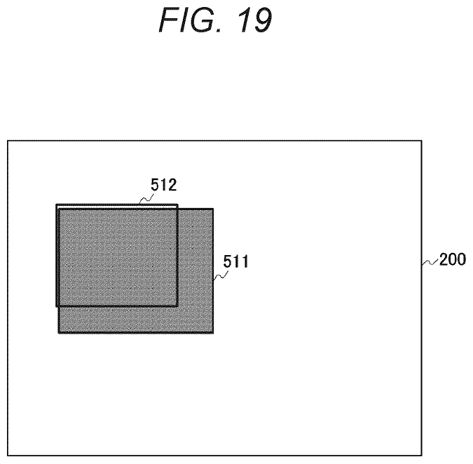

FIG. 19 is a diagram illustrating a second example of the distance measurement environment of the target object to be autofocused in the camera system according to the 11th embodiment.

In the drawing, it is assumed that a neighboring non-autofocus target 511 is illustrated in a two-dimensional image 200 generated by the imaging device 102. At this time, it is assumed that distant autofocus target 512 is hidden behind neighboring non-autofocus target 511.

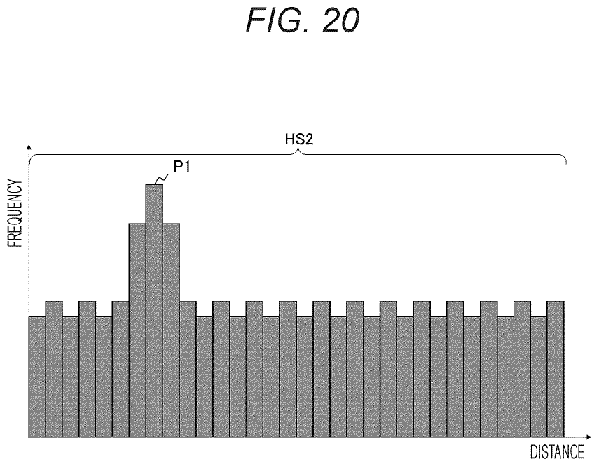

FIG. 20 is a diagram illustrating an example of a histogram in the second example of the distance measurement environment of the camera system according to the 11th embodiment.

In the drawing, the distance measurement sensor 101 generates a histogram HS2 of the SPAD reaction count based on reception of reflected light from a distant autofocus target 512 and a neighboring non-autofocus target 511.

In the histogram HS2, a peak P1 of the SPAD reaction count based on the reception of the reflected light from the neighboring non-autofocus target 511 occurs. On the other hand, since the distant autofocus target 512 is hidden behind the neighboring non-autofocus target 511, the peak P2 of the SPAD reaction count based on the reception of the reflected light from the distant autofocus target 502 does not occur. Here, calculating the distance to the autofocus target 512 on the basis of the peak detection of the histogram HS2 causes erroneous distance measurement. Therefore, the application processor 103 performs object recognition on the non-autofocus target 511 specified by the peak P1. In a case where the object recognition result of the non-autofocus target 511 specified at the peak P1 does not match the autofocus target 512, the application processor 103 rejects the distance measurement result of the non-autofocus target 511 specified at the peak P1. Then, the application processor 103 repeats imaging and ranging for a plurality of frames, and checks whether or not the peak P2 occurs for the autofocus target 512.

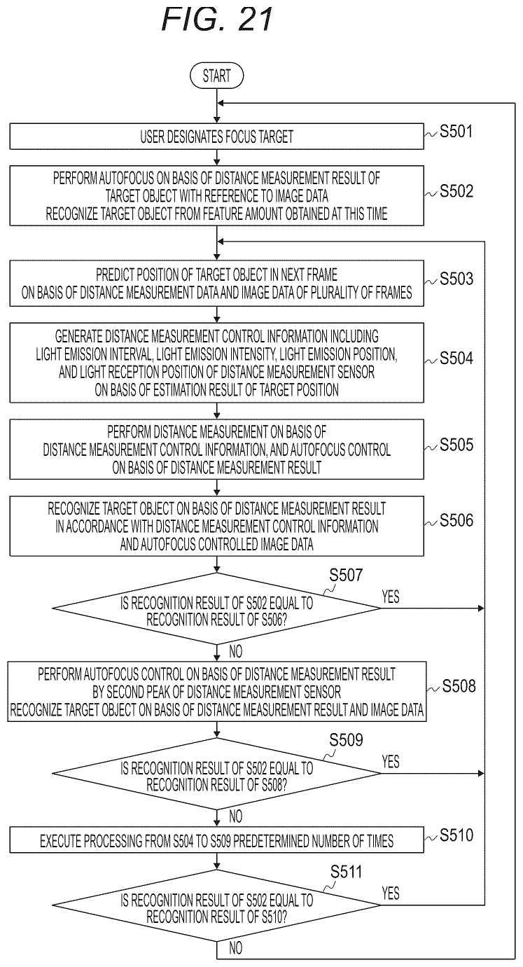

FIG. 21 is a flowchart illustrating an example of autofocus control of the camera system according to the 11th embodiment.

In the drawing, in the processing of S501 to S507, the camera system 100 performs the processing of S401 to S407 of the above-described 10th embodiment.

In a case where the object recognition result in S502 and the object recognition result in S506 are not equal to each other, the application processor 103 performs the autofocus control on the basis of the distance measurement result by the second peak of the distance measurement sensor 101. Note that the second peak is the second highest peak in the histogram. Then, the application processor 103 recognizes the focus target on the basis of the distance measurement result and the image data (S508).

Next, the application processor 103 determines whether the object recognition result in S502 and the object recognition result in S508 are equal to each other (S509). Note that, instead of determining whether the object recognition result in S502 and the object recognition result in S508 are equal to each other, the application processor 103 may determine whether the second peak in S508 is smaller than a predetermined value. In a case where the object recognition result in S502 is equal to the object recognition result in S508, the application processor 103 returns to the processing in S503. On the other hand, in a case where the object recognition result in S502 and the object recognition result in S508 are not equal to each other, the application processor 103 proceeds to the processing in S510.

At this time, the application processor 103 executes the processing from S504 to S509 a predetermined number of times (S510).

Next, the application processor 103 determines whether the object recognition result in S502 and the object recognition result in S510 are equal to each other (S511). In a case where the object recognition result in S502 is equal to the object recognition result in S510, the application processor 103 returns to the processing in S503. On the other hand, in a case where the object recognition result in S502 and the object recognition result in S510 are not equal to each other, the application processor 103 returns to the processing in S501.

As described above, in the above-described 11th embodiment, distance measurement for an autofocus target is performed while checking the autofocus target on the basis of a recognition result of the autofocus target. Accordingly, even in a case where there is a non-autofocus target in front of the autofocus target, autofocus control for the autofocus target can be performed.

### 12. Application Example to Mobile Body

The technology according to the present disclosure (present technology) can be applied to various products. For example, the technology according to embodiments of the present disclosure may also be implemented as a device mounted on any type of mobile body such as an automobile, an electric vehicle, a hybrid electric vehicle, a motorcycle, a bicycle, a personal mobility, an airplane, a drone, a ship, and a robot.

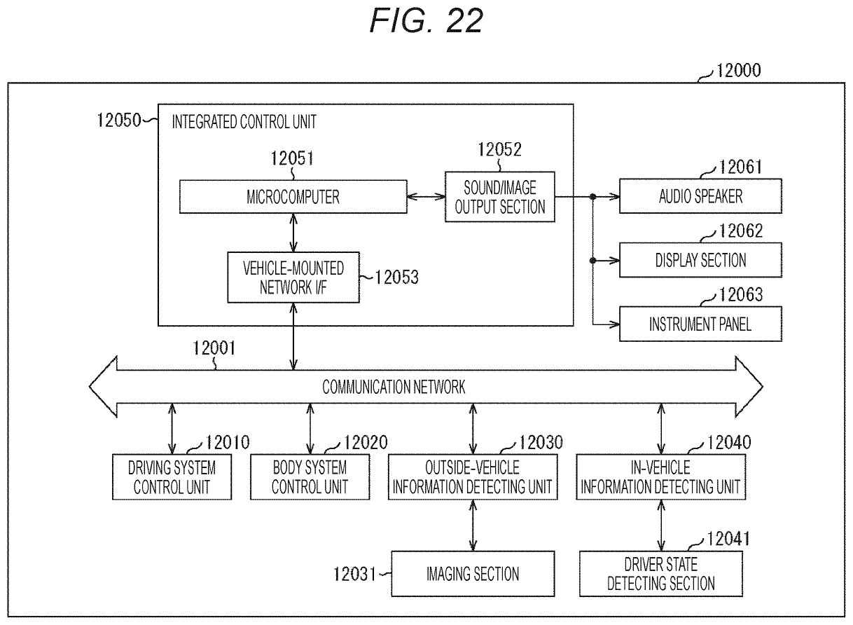

FIG. 22 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 22, an audio speaker 12061, a display section 12062, and an instrument panel 12063 are illustrated as the output device. The display section 12062 may, for example, include at least one of an on-board display and a head-up display.

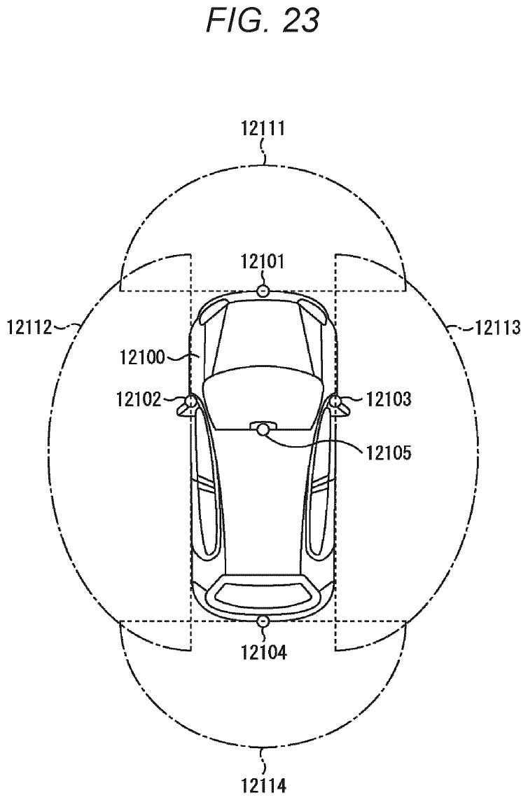

FIG. 23 is a diagram depicting an example of the installation position of the imaging section 12031.

In FIG. 23, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 23 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the configurations described above. Specifically, for example, the camera system 100 described above can be applied to the imaging section 12031. By applying the technology according to the present disclosure to the vehicle control system 12000, it is possible to reduce power consumption without deteriorating focus accuracy.

Note that the above-described embodiments illustrates an example for embodying the present technology, and the matters in the embodiments and the matters specifying the invention in the claims have a correspondence relationship. Similarly, the matters specifying the invention in the claims and the matters in the embodiments of the present technology denoted by the same names as the matters specifying the invention have a correspondence relationship. However, the present technology is not limited to the embodiments, and can be embodied by making various modifications to the embodiments without departing from the gist thereof. Furthermore, the effects described in the present specification are merely examples and are not limited, and other effects may be provided.

Note that the present technology can also have the following configurations.
(1) a camera system including:
   a distance measurement sensor that generates distance measurement data on the basis of distance measurement to a target object;
   an imaging device that generates image data on the basis of imaging of an imaging range including a distance measurement position of the target object; and
   an application processor that generates focus control information of the imaging device on the basis of the distance measurement data and the image data.
(2) The camera system according to (1), in which
   the application processor outputs distance measurement control information including at least any one of a light emission interval, a light emission intensity, a light emission position, a continuous light emission count, a light emission pulse width, or a light reception position to the distance measurement sensor.
(3) The camera system according to according to (1) or (2), further including
   a prediction section that predicts a three-dimensional position of the target object on the basis of the distance measurement data and the image data.
(4) The camera system according to (3), in which
   the prediction section predicts a three-dimensional position of the target object on the basis of a three-dimensional motion vector of the target object.
(5) The camera system according to (3) or (4), further including
   a control section that performs light emission control of the distance measurement sensor, light reception control of the distance measurement sensor, and focus control of the imaging device on the basis of a prediction result of a three-dimensional position of the target object.
(6) The camera system according to (5), in which
   the control section controls at least any one of a light emission interval, a light emission intensity, a light emission position, a continuous light emission count, a light emission pulse width, or a light reception position of the distance measurement sensor on the basis of a prediction result of a three-dimensional position of the target object.
(7) The camera system according to any one of (1) to (6), further including
   a display section that displays the target object and a three-dimensional motion vector of the target object.
(8) The camera system according to any one of (1) to (7), in which
   the application processor recognizes a position of the target object on the basis of image data obtained by phase difference autofocus, and performs focus control based on the distance measurement data on the basis of a recognition result of the position of the target object.
(9) The camera system according to claim 3 according to any one of (1) to (8), further including
   a recognition section that performs object recognition of the target object on the basis of the image data generated by the imaging device.
(10) The camera system according to (9), in which
   the control section performs focus control of the imaging device on the basis of an object recognition result recognized by the recognition section.
(11) An application processor including:
   a data input section that inputs distance measurement data to a target object and image data of an imaging range including a distance measurement position of the target object; and
   a data output section that outputs focus control information for imaging the target object on the basis of the distance measurement data and the image data.
(12) The application processor according to (11), in which
   the application processor outputs distance measurement control information including at least any one of a light emission interval, a light emission intensity, a light emission position, a continuous light emission count, a light emission pulse width, or a light reception position.
(13) The application processor according to (11) or (12), further including
   a prediction section that predicts a three-dimensional position of the target object on the basis of the distance measurement data and the image data.
(14) The application processor according to (13), in which
   the prediction section predicts a three-dimensional position of the target object on the basis of a three-dimensional motion vector of the target object.
(15) The application processor according to (14), further including
   a control section that performs light emission control of a distance measurement sensor, light reception control of the distance measurement sensor, and focus control of an imaging device on the basis of a prediction result of a three-dimensional position of the target object.
(16) The application processor according to (15), in which the control section controls at least any one of a light emission interval, a light emission intensity, a light emission position, a continuous light emission count, a light emission pulse width, or a light reception position of the distance measurement sensor on the basis of the prediction result of the three-dimensional position of the target object.
(17) The application processor according to any one of (11) to (16), the application processor being configured to
   output display control information of the target object and a three-dimensional motion vector of the target object.
(18) The application processor according to any one of (11) to (17), the application processor being configured to
   recognize a position of the target object on the basis of the image data obtained by phase difference autofocus, and perform focus control based on the distance measurement data on the basis of a recognition result of the position of the target object.
(19) The application processor according to any one of (11) to (18), further including
   a recognition section that performs object recognition of the target object on the basis of the image data including the target object.
(20) The application processor according to (19), in which
   the control section performs focus control of the imaging device on the basis of the object recognition result recognized by the recognition section.

### REFERENCE SIGNS LIST

100 Camera system
101 Distance measurement sensor
102 Imaging device
103 Application processor
104 IMU
105 Display section
111 Light emitting section
112 Light receiving section
113 Light emission control section
114 Light reception control section
115 Reading section
116 Light emission array section
117 Light emitting region
118 Light receiving array section
119 Light receiving region
121 Imaging section
122 Optical system
123 Reading section
124 Lens control section
126 Pixel array section
127 Pixel
131 Data output section
132 Data input section
133 Calculation section
134 Storage section
141 Control section
142 Prediction section
143 Recognition section
151 Acquired data
152 Distance measurement data
153 Image data
154 Frame acquisition time information
155 Processing program
156 Setting information

1. A camera system comprising:
a distance measurement sensor that generates distance measurement data on a basis of distance measurement to a target object;
an imaging device that generates image data on a basis of imaging of an imaging range including a distance measurement position of the target object; and
an application processor that generates focus control information of the imaging device on a basis of the distance measurement data and the image data.

2. The camera system according to claim 1, wherein
the application processor outputs distance measurement control information including at least any one of a light emission interval, a light emission intensity, a light emission position, a continuous light emission count, a light emission pulse width, or a light reception position to the distance measurement sensor.

3. The camera system according to claim 1, further comprising
a prediction section that predicts a three-dimensional position of the target object on a basis of the distance measurement data and the image data.

4. The camera system according to claim 3, wherein
the prediction section predicts a three-dimensional position of the target object on a basis of a three-dimensional motion vector of the target object.

5. The camera system according to claim 3, further comprising a control section that performs light emission control of the distance measurement sensor, light reception control of the distance measurement sensor, and focus control of the imaging device on a basis of a prediction result of a three-dimensional position of the target object.

6. The camera system according to claim 5, wherein
the control section controls at least any one of a light emission interval, a light emission intensity, a light emission position, a continuous light emission count, a light emission pulse width, or a light reception position of the distance measurement sensor on a basis of a prediction result of a three-dimensional position of the target object.

7. The camera system according to claim 1, further comprising a display section that displays the target object and a three-dimensional motion vector of the target object.

8. The camera system according to claim 1, wherein
the application processor recognizes a position of the target object on a basis of image data obtained by phase difference autofocus, and performs focus control based on the distance measurement data on a basis of a recognition result of the position of the target object.

9. The camera system according to claim 1, further comprising
a recognition section that performs object recognition of the target object on a basis of the image data generated by the imaging device.

10. The camera system according to claim 9, wherein
the control section performs focus control of the imaging device on a basis of an object recognition result recognized by the recognition section.

11. An application processor comprising:
a data input section that inputs distance measurement data to a target object and image data of an imaging range including a distance measurement position of the target object; and
a data output section that outputs focus control information for imaging the target object on a basis of the distance measurement data and the image data.

12. The application processor according to claim 11, wherein
the application processor outputs distance measurement control information including at least any one of a light emission interval, a light emission intensity, a light emission position, a continuous light emission count, a light emission pulse width, or a light reception position.

13. The application processor according to claim 11, further comprising
a prediction section that predicts a three-dimensional position of the target object on a basis of the distance measurement data and the image data.

14. The application processor according to claim 13, wherein
the prediction section predicts a three-dimensional position of the target object on a basis of a three-dimensional motion vector of the target object.

15. The application processor according to claim 13, further comprising
a control section that performs light emission control of a distance measurement sensor, light reception control of the distance measurement sensor, and focus control of an imaging device on a basis of a prediction result of a three-dimensional position of the target object.

16. The application processor according to claim 15, wherein
the control section controls at least any one of a light emission interval, a light emission intensity, a light emission position, a continuous light emission count, a light emission pulse width, or a light reception position of the distance measurement sensor on a basis of the prediction result of the three-dimensional position of the target object.

17. The application processor according to claim 11, the application processor being configured to
output display control information of the target object and a three-dimensional motion vector of the target object.

18. The application processor according to claim 11, the application processor being configured to
recognize a position of the target object on a basis of the image data obtained by phase difference autofocus, and perform focus control based on the distance measurement data on a basis of a recognition result of the position of the target object.

19. The application processor according to claim 11, further comprising
a recognition section that performs object recognition of the target object on a basis of the image data including the target object.

20. The application processor according to claim 19, wherein
the control section performs focus control of the imaging device on a basis of the object recognition result recognized by the recognition section.
